(19) United States
(12) Patent Application Publication
(10) Pub. No.: US 2009/0090429 A1
(43) Pub. Date: Apr. 9, 2009

(54) CATALYST LOADING APPARATUS

(75) Inventors: Garry Cochrane, Cleveland (GB); David Evans Foster, Cleveland (GB); Paul McLaughlin, Cleveland (GB); Michael Peter Roberts, Cleveland (GB)

Correspondence Address: RATNERPRESTIA, P.O. BOX 980, VALLEY FORGE, PA, 19482, US

(73) Assignee: Johnson Matthey PLC, London (GB)

(21) Appl. No.: 12/089,308

(22) PCT Filed: Sep. 20, 2006
(86) PCT No.: PCT/GB2006/050297

§ 371 Date: Apr. 4, 2008

(30) Foreign Application Priority Data
Oct. 4, 2005 (GB) 0520088.6

(51) Int. Cl. B01J 8/06; B65G 69/02; B65B 1/06

(52) U.S. Cl. 141/1; 422/145; 141/251; 141/12

(57) ABSTRACT

A method for loading a particulate catalyst into a vertical catalyst tube includes (i) introducing catalyst loading apparatus into a vertical catalyst tube, (ii) loading catalyst particles into the top of the tube whereinafter they contact the apparatus as they pass down the tube, forming a uniform bed of catalyst beneath the apparatus and (iii) simultaneously removing the apparatus from the catalyst tube in timed relationship to the catalyst loading, wherein the apparatus includes one or more deflector units, each deflector unit including a plurality of inclined deflector plates arranged on a rigid elongate member such that all the catalyst particles are deflected by one or more of the plates as they pass through the or each unit.

This invention relates to methods and apparatus for loading particulate catalyst into vertical tubes.

Catalyst-filled tubes are widely used in heat exchange reactors where the reaction mixture is heated or cooled by a heat exchange medium passing around the exterior of the tubes. In particular, such reactors are well known and widely used for the catalytic steam reforming of hydrocarbons wherein a mixture of hydrocarbon, typically methane, and steam are passed at elevated pressure over a particulate reforming catalyst, such as Ni on alumina, disposed within tubes that are externally heated to high temperatures by a hot gas mixture.

Traditional methods for loading catalyst pellets into vertical tubes such as sock-loading or wet-loading do not satisfactorily overcome the problem of particle bridging. Particle bridging can lead to voids within the tubes that create differences in tube-to-tube pressure drop and hence flowrate, extent of reaction, heat flow, temperature and, in high-temperature stream reforming processes, premature failure of the tubes. Traditional loading methods are slow and with the development of larger heat exchange reactors containing many more tubes, there is a need to develop faster methods for economically loading catalyst pellets into tubes in a consistent manner. However the requirement of fast loading competes with the requirement for minimal catalyst breakage. Catalyst breakage leads to the formation of ‘fines’ that can block the flow of gases through the catalyst filled tube thereby causing increased pressure drop. Higher pressure drop leads to reduction in plant throughput, imbalance of flow and in steam reforming can lead to tube overheating and tube failure.

U.S. Pat. No. 3,608,751 describes a catalyst loading method wherein the catalyst loading apparatus comprises a flexible line supporting spaced pairs of inclined blades. The apparatus is lowered into the tube, particulate catalyst is loaded from the top of the tube and at the same time the line is withdrawn. This apparatus is not, to the knowledge of the applicants, in current use, presumably as the particles appear able to by-pass the blades.

U.S. Pat. No. 5,247,970 describes a catalyst loading method wherein damper brushes, e.g. in the form of radially extending springs, are provided on a flexible line to slow the catalyst pellets as they descend in the tube. Such apparatus is used commercially, however the maximum rate of catalyst loading is limited and faster loading rates are desired.

We have developed a method and apparatus offering reduced breakage and faster loading than previously possible.

Accordingly the invention provides a method for loading a particulate catalyst into a vertical catalyst tube comprising;
(i) introducing catalyst loading apparatus into a vertical catalyst tube,
(ii) loading catalyst particles into the top of the tube whereinafter they contact said apparatus as they pass down the tube forming a uniform bed of catalyst beneath said apparatus and
(iii) simultaneously removing the apparatus from the catalyst tube in timed relationship to the catalyst loading, wherein said apparatus comprises one or more deflector units, each deflector unit comprising a plurality of inclined deflector plates arranged on a rigid elongate member such that all the catalyst particles are deflected by one or more of said plates as they pass through each unit.

The invention also provides the catalyst loading apparatus used in the method.

The catalyst tubes are typically cylinders 10-15 metres in length with an internal diameter of 7.5-15 cm. Perforate catalyst restraining means such as a grid or mesh are typically provided at the bottom of the tube to support the catalyst particles.

The catalyst particles may be spheres, cylinders, rings or other catalyst shapes of particle size in the range 10-30 mm formed, for example, by extrusion or pelleting. By ‘particle size’ we mean the smallest catalyst particle dimension such as length or diameter. The catalyst particles preferably have an aspect ratio <2, more preferably ≦1.5. By “aspect ratio” we mean the length/diameter or width. Typically in smaller tubes, smaller particles are used, but any combination of particle size may be employed in the present invention as long as the loading apparatus is sized appropriately for the smallest catalyst particles chosen. We have found the present invention to be especially useful for lobed or fluted cylinders, particularly multi-holed lobed or fluted cylinders having an aspect ratio <2. These catalyst particles, because of the lobes and flutes, may be at greater risk of bridging or breakage upon loading using traditional loading methods. However the lobed or fluted particles have been found to offer considerable improvements in reducing pressure drop whilst maintaining conversion activity, particularly in steam reforming processes.

The loading apparatus comprises one or more deflector units. In order for all the catalyst particles to be deflected by each deflector unit, the deflector plates should preferably be arranged on the elongate member so that they, when viewed from above, define a deflecting surface around which there is a gap between the peripheral edge of the plates and the inside wall of the catalyst tube, this gap having a width less than half the size of the smallest catalyst particle dimension. Thus for a tube of circular cross-section the deflector plates should, when viewed from above, preferably define a circular surface having an annular void around the periphery whose width is less than half the size of the smallest catalyst particle dimension. To achieve this the diameter of the surface is preferably at least one smallest catalyst particle dimension less than the internal diameter of the tube, i.e. the difference in the diameter of the surface and the internal diameter of the tube is preferably less than one smallest particle dimension. Of course, it is necessary that the diameter of such a surface is less than the internal diameter of the tube so that the apparatus does not become jammed within the tube. We have found that a gap around the deflector plates between about one half and about one quarter catalyst particle size (minimum catalyst particle dimension) is preferred. The apparent surface when viewed from above need not be continuous but any gaps and/or orifices in the apparent surface should be smaller than the minimum catalyst particle dimension to prevent catalyst particles by-passing the deflector unit.

Arranging the deflector plates in this way ensures that all the catalyst particles contact at least one of the deflector plates in each deflector unit. Furthermore this arrangement allows for some movement of the apparatus within the tubes without compromising the loading process.

Each deflector unit comprises an elongate member and a plurality of inclined deflector plates fixed to the elongate member. In the present invention, the elongate member on which the plates are mounted or fixed is rigid. The rigid elongate members are preferably rods, which may have polygonal, oval, ring or preferably circular cross section. Such elongate members are suitably fabricated from steel or alternatively a lightweight rigid material may be used. The elongate members are preferably 10-100 cm in length, more preferably 10-60 cm in length. By using a rigid elongate member it is possible to fix the deflector plates in an arrangement whereby all the catalyst particles are deflected. In the aforesaid U.S. Pat. No. 3,608,751 inclined blades were fixed to a flexible rope and therefore the blades were able to twist or move relative to each other during catalyst loading thereby allowing catalyst particles to bypass the blades.

The deflector units may be connected directly to each other but are preferably separated at 0.5 to 2.5 metre intervals, more preferably 1 to 2 m intervals by a suitable flexible rope, cable or wire. In use, the uppermost deflector unit is preferably suspended within the catalyst tube by means of a flexible rope, cable or wire up to 2.5 metres from the top of the tube. The connections between deflector units may be by means of hooks, interlocking hoops, so-called universal joints or the like. Preferably the connections allow ready assembly and disassembly of the loading apparatus as this permits apparatus to be readily adapted to the tube length and permits different deflector units having different deflector plate arrangements to be used for catalyst loading in each tube. Furthermore, transportation to and from the reactor of the apparatus is simplified.

The catalyst loading apparatus therefore preferably comprises a plurality of deflector units, each unit comprising a rigid elongate member on which is supported inclined plates wherein each unit is separated by a length of flexible rope cable or wire.

Preferably in each deflector unit the elongate member supports between 1 and 20 deflector plates, more preferably between 2 and 8 deflector plates. The deflector plates are preferably fabricated from a rigid material such as metal or plastic. If desired, the deflector plates may be fabricated from the same material as the elongate member, e.g. steel, to simplify fabrication. If desired, the deflector plates may be coated with a resilient material. In a preferred embodiment, the deflector plates are fabricated from a resilient plastic such as polypropylene. This allows ready fabrication of the plates, and should the tube become blocked during loading, a vacuum hose may be inserted down the inside of the tube with the loading apparatus in place with enough force to displace the plates without causing permanent damage to the units. Polypropylene plates are preferably 1-3 mm in thickness.

The plates may be fixed to the elongate members using suitable methods such as welding, gluing or similar methods. In a preferred embodiment, the elongate member comprises a plurality of sub-units that may be fixed together. For example, the sub-units may be threaded at their ends so that they may be screwed together. Deflector plates may then readily be fixed between the sub units.

The deflector plates may be spaced evenly along the elongate member. Alternatively the deflector plates may be supported as opposed in pairs. One or more opposed pairs may be present on each deflector unit. The plates are preferably <100 cm apart with the smallest spacing dictated by the catalyst particle size. Preferably the deflector plates are 1-50 cm apart, more preferably 0.5-1.0 tube internal diameters apart, especially 5-10 cm apart.

The deflector plates are inclined. By this we mean that they are inclined to the axis of flow of the catalyst particles, which is generally the same as the axis of the catalyst tube to be loaded and therefore also of the elongate member. The tubes to be loaded are typically disposed vertically within the reactor. The inclination of each deflector plate to the axis may be in the range 30-60 degrees, preferably 40 to 50 degrees, more preferably about 45 degrees as this has been found to be optimum for the competing requirements of reduced breakage and fast loading.

Preferably the inclined deflector plates present an uppermost or leading edge that is curved. We have found that by having the uppermost edges of the deflector plates curved, the amount of catalyst breakage is reduced compared to deflector means having horizontal leading edges. Without wishing to be bound by theory, it is believed that the curved edge is able to deflect the energy of particles impacting upon it tangentially and therefore reduces the likelihood of particles breaking.

The elongate member has a plurality of deflector plates that define a path for the catalyst particles as they fall down through the deflector unit. As stated above, when viewed from above the deflector plates may define a circular deflecting surface. Accordingly the deflector plates may take the form of sectors of a circle, joined to the elongate member at the apex of the radial edges. In this case, the sectors may be defined by the angle between the radial edges. For example where a sector has radial edges at an angle of 45 degrees to each other when viewed from above, 8 such sectors will be required to form a complete circle when viewed from above. Similarly 60 degrees requires 6 sectors, 90 degrees requires 4 sectors, 120 degrees requires 3 sectors and 180 degrees requires two sectors. In the last case the radial edges form a diameter edge that it joined to the elongate member at its centre. Where the plates are arranged as opposed pairs, to prevent bypass of catalyst particles, the diameters running through each pair are preferably arranged so that the plates define a circular deflecting surface. For example, where 6 sectors are arranged along the elongate member as three opposed pairs, in order to prevent catalyst particles from by-passing the plates, the diameters running through the plates should be about 120 degrees to each other.

The deflector plates arranged on the elongate member may be the same or different, i.e. differently shaped sectors may be attached along the member, but preferably the sectors are the same to simplify fabrication.

In each case the upper edge of the deflector plate is preferably curved. In a preferred embodiment, the radial edges of the sectors are inwardly curved. By “inwardly curved” we mean that the radial edges of the sector are deflected inwards when viewed from above. In such cases the size of the sectors should be adjusted so that catalyst particles are not able to by-pass the deflector unit. Furthermore, it will be understood that for the deflector plates to form sectors of a circle when viewed from above, the curved circumferential edges of the deflector plates may need to be elliptical to take into account the angle of inclination of the deflector plates.

The faces of the deflector plates may be curved in the way of a propeller blade but are preferably flat to simplify fabrication.

In preferred arrangements the deflector plates are either semicircles or quadrants when viewed from above. Hereinafter such deflector plates are termed semicircular or quadrant, but it will be understood that the actual shapes of the deflector plates will require adjustment to take into account the angle of inclination and prevent by-pass of catalyst particles at the periphery of the unit.

In a first embodiment of a deflector unit, pairs of semicircular deflector plates are fixed in spaced relationship along the elongate member with the diameter edges of the paired deflector plates parallel to each other and the faces preferably perpendicular. This permits the catalyst particles to flow downwards in a repeating serpentine manner.

In a second embodiment, pairs of semicircular deflector plates are fixed to the elongate member in opposed relationship with the diameter edges and faces of the paired deflector plates perpendicular to each other. Preferably each pair of deflector plates is arranged so that the diameter edges are perpendicular to the subsequent or preceding pair. This permits the catalyst particles to flow downwards in a circuitous manner.

In a preferred embodiment with quadrant deflector plates, the deflector plates are disposed with one radial edge horizontal and perpendicular to the elongate member.

Pairs of such quadrants may be fixed in spaced relationship along the elongate member with each pair of quadrants in an adjacent relationship such that two of the radial edges are co-linear, i.e., the two radial edges perpendicular to the elongate member form a diameter across the tube. Where such pairs are employed, preferably the co-linear radial edges of one pair form a diameter perpendicular to the co-linear radial edges of a subsequent or previous pair.

In a particularly preferred embodiment the loading apparatus comprises one or more units having three opposed pairs of sector deflector plates whose radial edges are inwardly curved. The sector angle is preferably about 60 degrees. Diameters passing through the elongate member bisect the plates. The opposed pair diameters are therefore preferably at an angle of about 120 degrees to each other such that catalyst particles descending through the unit will strike at least one plate. The plates are inclined at an angle of about 45 degrees to the elongate member. The inclination of the plates is arranged within the unit so that the catalyst particles follow a circuitous path as they descend. In this embodiment, it is preferred to fabricate each pair from one piece of resilient plastic, e.g. polypropylene, and form the unit from sub-units connected together through the apex of the three opposed pairs of sector deflector plates.

The loading apparatus according to the present invention may comprise a plurality of the same or different deflector units in any arrangement. For example one or more deflector units having semicircular plates may be disposed above one or more units having quadrant plates.

Alternatively, the loading apparatus may comprise a plurality of 6-plate units, wherein the plates are arranged as three opposed pairs.

In order to prevent the apparatus from rotating within the tube during loading, it is preferred where the catalyst particles follow a circuitous path as they descend, that the plates are arranged on the elongate members such that the particles move in a balanced clockwise and anticlockwise manner. Preferably, the units comprise a plurality of plates that direct the particles either clockwise or anti-clockwise and the units are arranged within the tube such that the particles alternate between clockwise and anticlockwise rotation as they descend through the tube.

The catalyst particles are loaded into the top of the tube by conventional means and fall under gravity down the tube, impacting the surfaces and edges of the loading apparatus en-route. When the particles encounter a deflector unit, they are deflected against the inside of the tube wall thereby reducing their vertical velocity and are unable to pass around the periphery of the deflector plates. The catalyst particles may then fall vertically to the bottom of the tube or preferably to another deflector unit suspended up to 2.5 metres beneath and so on until the particles are deposited at the top of the growing bed of catalyst. As the bed of catalyst particles grows upwards, the apparatus is simultaneously withdrawn from the tube, maintaining the lowest deflector unit within 2.5 metres, preferably 1.5 metres, most preferably within 1 metre of the surface of the growing bed.

The catalyst loading apparatus may be introduced into and/or withdrawn from the tube manually, however it is preferable to use means for introducing and removing said apparatus from catalyst tubes such as a winch or other such lifting/lowering apparatus in order to maintain a controlled lifting rate as the catalyst is loaded. Furthermore, whereas catalyst may be loaded manually, e.g. from drums, catalyst particles are preferably fed to the tube in a controlled manner using e.g. a vibrating feeder. This improves the catalyst particle packing within the tube.

The invention is further described by reference to the following drawings in which;

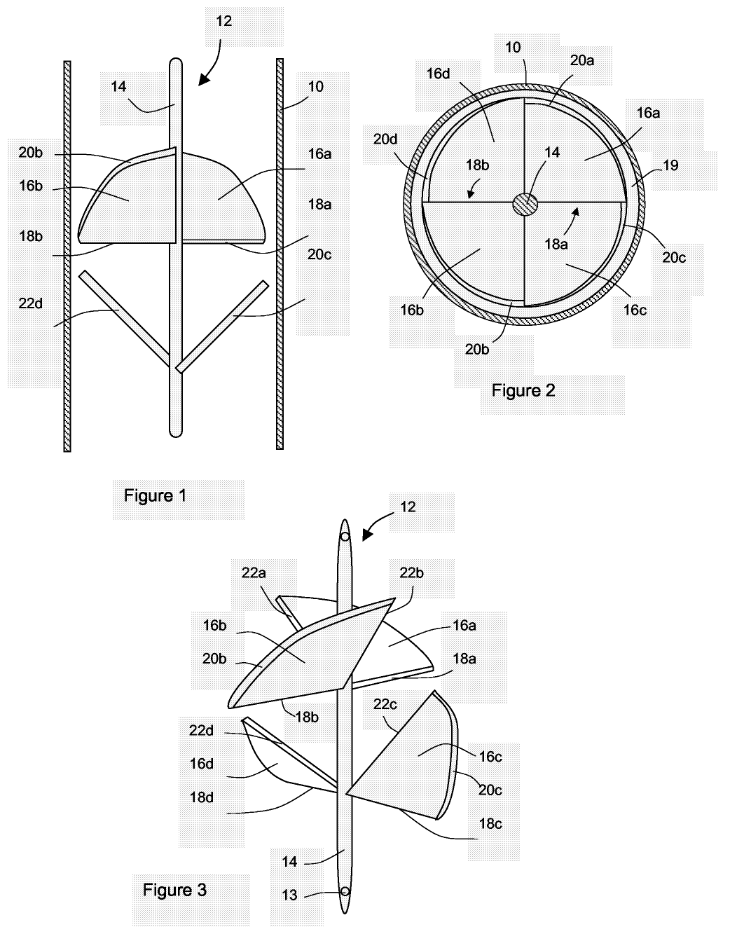

FIGS. 1, 2 and 3 depict side, top and oblique views of one embodiment of a deflector unit having quadrant deflector plates;

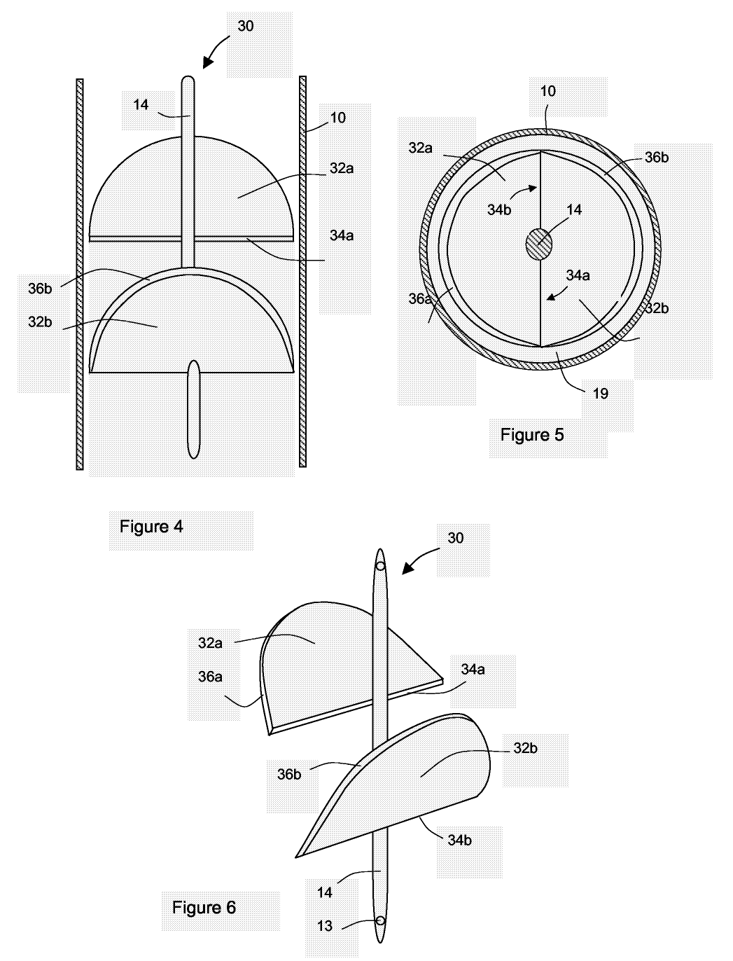

FIGS. 4, 5 and 6 depict side, top and oblique views of a first embodiment of a deflector unit having semicircular deflector plates;

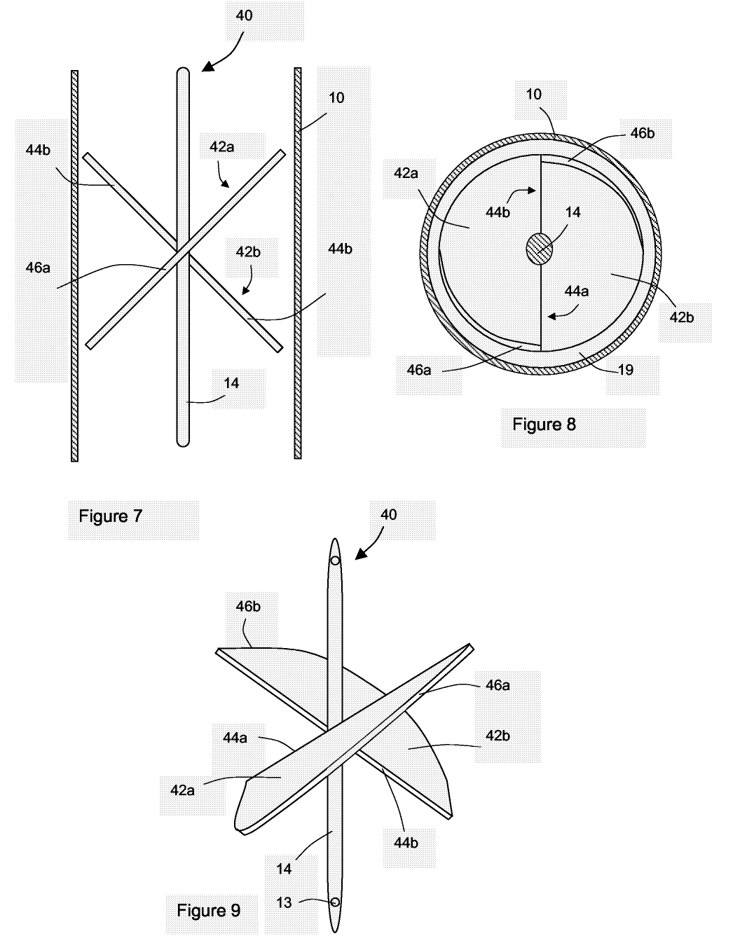

FIGS. 7, 8 and 9 depict side, top and oblique views of a second embodiment of a deflector unit having semicircular deflector plates, and

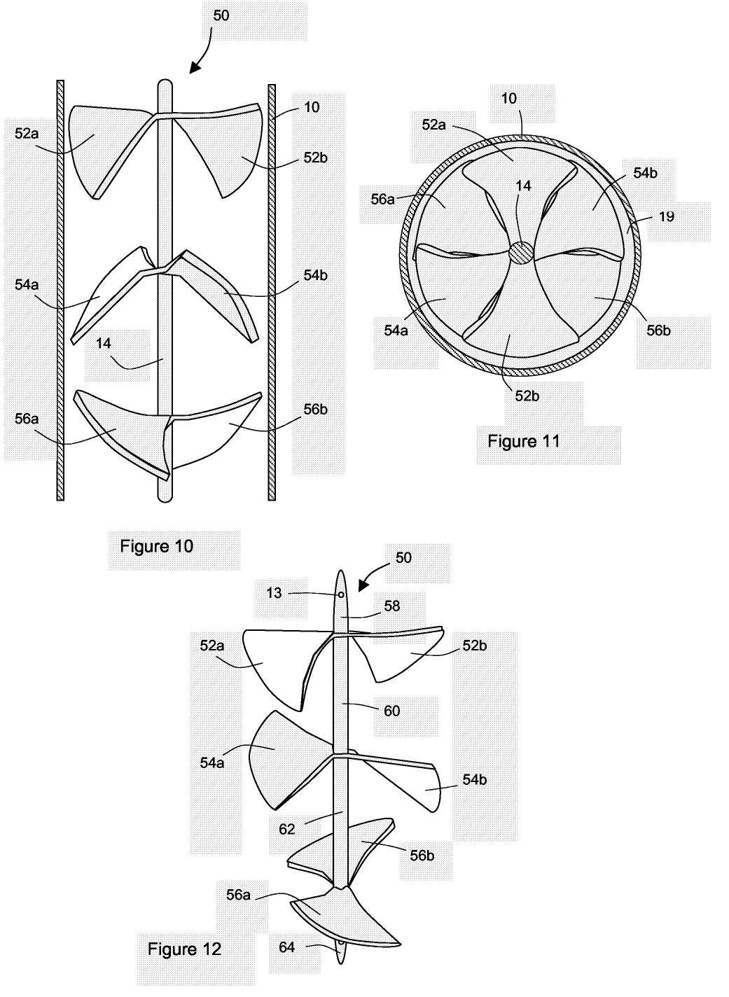

FIGS. 10, 11 and 12 depict side, top and oblique views of an embodiment of a deflector unit having three opposed pairs of sector deflector plates whose radial edges are inwardly curved.

In FIG. 1, a catalyst tube 10 encloses the apparatus 12 (see FIG. 3) comprising a rigid rod 14 supporting two spaced apart pairs of quarter elliptical deflector plates 16a, 16b, 16c and 16d, each fixed to said rod at the apex of the radial edges. The pairs of plates 16a, 16b and 16c, 16d are spaced 0.5 of the tube internal diameter apart to allow free flow without bypassing or excessive fall. At the top and bottom of the rod are connecting means (not shown) that connect the rod through holes 13 via a length of cable to other deflector plate-carrying rigid members (not shown). The upper pair of deflector plates 16a and 16b are fixed to rod 14 with their straight radial edges 18a and 18b co-linear and perpendicular to the rod. The faces of the deflector plates 16a and 16b are inclined at about 45 degrees to the axis of the tube and at about 90 degrees to each other. The lower pair 16c and 16d are fixed to the rod also with their straight radial edges 18c and 18d co-linear and perpendicular to the rod, and with their faces inclined at about 45 degrees to the axis of the tube and about 90 degrees to each other. The edges 18a/18b and 18c/18d and therefore also the upwardly inclined radial edges 22a/22b and 22c/22d are at 90 degrees to each other so that when viewed from the top (see FIG. 2) the deflector plates 16a-d form a circle with the circumferential outer edges of the deflector plates 20a-d defining an annular space 19 between the curved outer edges of the deflector plates 20 and the interior wall of the tube 10.

In use, the apparatus is suspended within the catalyst tube by means of a flexible rope, cable or wire up to 2.5 metres from the top of the tube. Catalyst particles are loaded in at the top of the tube and fall vertically to the apparatus wherein they contact the inclined surfaces of one or more of plates 16a, 16b, 16c and 16d that deflect all the particles thereby reducing their vertical velocity. The particles may then fall to the next deflector unit, which may be same or different and so on until the particles are deposited at the top of the growing catalyst bed.

In FIG. 4 a catalyst tube 10 encloses the apparatus 30 (see FIG. 6) comprising a rigid rod 14 supporting two spaced apart half elliptical deflector plates 32a and 32b, each deflector plate fixed to said rod at the middle of its diameter edge. At the top and bottom of the rod are connecting means (not shown) that connect the rod through holes 13 via a length of cable to other deflector plate-carrying rigid members (not shown). The upper and lower deflector plates 32a and 32b are fixed to rod 14 with their diameter edges 34a and 34b parallel to each other and perpendicular to the axis of the tube 10. The distance between the edges 34a-b is about 0.5 of the tube internal diameter to allow free flow without bypassing or excessive fall. The faces of the deflector plates 32a and 32b are inclined upwards at about 45 degrees to the axis of the tube and at about 90 degrees to each other. When viewed from the top (see FIG. 5) the deflector plates 32a-b form a circle with the circumferential outer edges of the deflector plates 36a and 36b defining an annular space 19 between the curved outer edges of the deflector plates 36 and the interior wall of the tube 10.

In use, the apparatus is suspended within the catalyst tube by means of a flexible rope, cable or wire up to 2.5 metres from the top of the tube. Catalyst particles are loaded in at the top of the tube and fall vertically to the apparatus wherein they contact the inclined surface of plate 32a and then the inclined surface of plate 32b and are deflected against the internal walls of the tube thereby reducing their vertical velocity. The particles may then fall to the next deflector unit, which may be same or different and so on until the particles are deposited at the top of the growing catalyst bed.

In FIG. 7 a catalyst tube 10 encloses the apparatus 40 (see FIG. 9) comprising a rigid rod 14 supporting two opposed half elliptical deflector plates 42a and 42b each deflector plate fixed to said rod at the middle of its diameter edge. At the top and bottom of the rod are connecting means (not shown) that connect the rod through holes 13 via a length of cable to other deflector plate-carrying rigid members (not shown). The opposed deflector plates 42a and 42b are fixed to rod 14 with their diameter edges 44a and 44b at about 90 degrees to each other and at about 45 degrees to the axis of the tube 10. The faces of the deflector plates 42a and 42b are therefore also inclined at about 45 degrees to the axis of the tube and at about 90 degrees to each other. When viewed from the top (see FIG. 8) the deflector plates 42a-b form a circle with the circumferential outer edges of the deflector plates 46a and 46b defining an annular space 19 between the curved outer edges of the deflector plates 46 and the interior wall of the tube 10.

In use, the apparatus is suspended within the catalyst tube by means of a flexible rope, cable or wire up to 2.5 metres from the top of the tube. Catalyst particles are loaded in at the top of the tube and fall vertically to the apparatus wherein they simultaneously contact the inclined surfaces of plates 42a and 42b and are deflected against the internal walls of the tube thereby reducing their vertical velocity. The particles may then fall to the next deflector unit, which may be same or different and so on until the particles are deposited at the top of the growing catalyst bed.

In FIG. 10 a catalyst tube 10 encloses the apparatus 50 comprising a rigid rod 14 supporting the evenly spaced opposed pairs of sector deflector plates 52a-52b, 54a-54b, and 56a-56b, each deflector plate fixed to said rod at the apex of the sector. The rod 14 is comprised of four sub-units (see FIG. 12) 58, 60, 62 and 64 that are alternately internally and externally threaded and screw together. The opposed pairs of deflector plates 52a-52b, 54a-54b, and 56a-56b are attached at the joints where the sub-units screw together. At the top and bottom of the rod are connecting means (not shown) that connect the rod through holes 13 in sub-units 58 and 64 via a length of cable to other deflector plate-carrying rigid members (not shown). The opposed pairs of deflector plates 52a-52b, 54a-54b, and 56a-56b have their upper faces inclined at about 90 degrees to each other and at about 45 degrees to the axis of the tube 10.

The plates 52, 54, 56 in this embodiment are arranged so that the catalyst particles follow an anti-clockwise rotational path as they descend through the unit. It will be understood that by rotating the axis of inclination for each plate by 90 degrees that the unit would produce clockwise rotation. When viewed from the top (see FIG. 11) the opposed pairs of deflector plates 52a-52b, 54a-54b, and 56a-56b form a circle with the circumferential outer edges of the deflector plates defining an annular space 19 between the curved outer edges of the deflector plates and the interior wall of the tube 10.

In use, the apparatus is suspended within the catalyst tube by means of a flexible rope, cable or wire up to 2.5 metres from the top of the tube. Catalyst particles are loaded in at the top of the tube and fall vertically to the apparatus wherein they contact the inclined surfaces of plates 52a-52b, 54a-54b, and 56a-56b and are deflected against the internal walls of the tube thereby reducing their vertical velocity. The particles may then fall to the next deflector unit, which may be same or different and so on until the particles are deposited at the top of the growing catalyst bed.

Whereas the present apparatus and method are described for loading a particulate catalyst, the apparatus and method are equally suited for loading other particulate materials such as absorbents into vertical tubes.

The invention is further illustrated by reference to the following Examples.

### EXAMPLE 1

The advantages of the loading method and apparatus were demonstrated loading a 100 mm internal diameter tube, 4.2 m long. First, catalyst particles were loaded by free fall into an empty tube at different flow rates. This was then repeated using the loading apparatus of the present invention, demonstrating fast loading and significantly reduced breakage.

The catalyst particles were fluted, 4 hole cylindrical pellets of diameter 13 mm and length 16 mm.

In the empty tube test, 0.82 litres of pellets (approximately 240 pellets) were loaded. The loading rate is expressed in metres increase in height of the surface of the catalyst bed within the tube/minute.

| Rate m/min | Breakage (no) | Breakage (%) |
|---|---|---|
| 1.07 | 4 | 1.7 |
| 1.07 | 4 | 1.7 |
| 1.44 | 5 | 2.1 |
| 1.44 | 5 | 2.1 |
| 1.57 | 4 | 1.7 |
| 1.57 | 5 | 2.1 |
| 1.97 | 3 | 1.3 |
| 1.97 | 4 | 1.7 |
| 1.98 | 6 | 2.5 |
| 1.98 | 6 | 2.5 |
| | Average | 1.9 |

In the next test 6.5 kg (8.8 litres) of pellets (approximately 2600 pellets) were loaded using an embodiment of the present invention.

The loading apparatus had 4 deflector units separated at 1 metre distances. The bottom deflector unit was as described in FIGS. 1-3 and the other deflector units as described in FIGS. 4-6. The deflector plates were made from steel, with deflector plates set at 45 degrees to the horizontal and the annular (peripheral) gap around the plates to the tube wall set at 3 mm (i.e. about 0.25 of a catalyst minimum dimension). The deflector units were 170 mm in length and connected together by 1 m long, 3 mm diameter flexible steel cable using crimped loops and shackles. The horizontal lower edges of the deflector plates were 5 cm apart in each of the units. The distance between the bottom defector unit and the catalyst bed surface was maintained at approximately 1 m during catalyst loading by simultaneously raising the apparatus as the catalyst articles were added.

| Rate m/min | Breakage (no) | Breakage (%) |
|---|---|---|
| 1.44 | 0 | 0.00 |
| 1.44 | 0 | 0.00 |
| 1.44 | 1 | 0.04 |
| 1.57 | 1 | 0.04 |
| 1.57 | 0 | 0.00 |
| 1.57 | 0 | 0.00 |
| 1.97 | 1 | 0.04 |
| 1.97 | 1 | 0.04 |
| 1.97 | 1 | 0.04 |
| 1.98 | 0 | 0.00 |
| 1.98 | 0 | 0.00 |
| 1.98 | 0 | 0.00 |
| | Average | 0.016 |

The use of the loading device described here reduced the free fall breakage by a factor of more than 100, and enabled loading rates that would fill a 12 m tube in 6.1 minutes.

### EXAMPLE 2

The advantages of the loading method and apparatus of the present invention were demonstrated loading a full-scale 101 mm internal diameter tube, 12.7 m long. First, catalyst particles were loaded by free fall into an empty tube. This was then repeated using the loading apparatus of the present invention at different flow rates, demonstrating fast loading and significantly reduced breakage.

These demonstrations were conducted using two sizes of catalyst particles. The first size were fluted, 4 hole cylindrical pellets of diameter 16 mm and length 19 mm, referred to hereinafter as “large pellets.” The second size were fluted, 4 hole cylindrical pellets of diameter 11 mm and length 13 mm, referred to hereinafter as “small pellets.”

In the empty tube, two buckets each containing 8.0 kg of pellets were loaded. The loading rate is expressed in metres/minute increase in height of the surface of the catalyst bed within the tube. Breakages are expressed in the percentage of the loaded weight of catalyst pellets that are less than three quarters of an intact pellet when unloaded.

| | Large Pellets | Small Pellets |
|---|---|---|
| Bucket 1 Loading Rate (m/min) | 3.71 | 3.80 |
| Bucket 2 Loading Rate (m/min) | 3.57 | 4.16 |
| Average Loading Rate (m/min) | 3.63 | 3.97 |
| Breakages (% w/w) | 24.50 | 7.13 |

Following the filling using empty tubes, the filling was then tested for comparison using the loading apparatus according to the present invention. The loading apparatus had deflector units separated at 1 metre distances. All the deflector units were as depicted in FIGS. 10-12 but with the plates in each unit arranged to provide alternating clockwise and anticlockwise rotation of the catalyst particles. The deflector plates were made from 1 mm thick polypropylene, with the plates angled at 45 degrees to the horizontal and the annular gap between the plates and tube wall less than 3 mm (i.e. about 0.27 of a small catalyst minimum dimension) to ensure that no pellets bypassed the blades.

The deflector units were 190 mm in length and connected by 1 m long, 3 mm diameter flexible steel cable using crimped loops and shackles. The deflector plates were mounted 65 mm apart in each of the units. The distance between the bottom deflector unit and the catalyst bed surface was maintained at approximately 1 m during catalyst loading by simultaneously raising the apparatus as the catalyst pellets were added.

| Large Pellet Loading | Breakages |
|---|---|
| Rate (m/min) | (% w/w) |
| 3.89 | 0.90 |
| 2.57 | 1.38 |
| 1.80 | 1.00 |
| 0.84 | 0.88 |

The average breakage resulting from loading large pellets using this apparatus is 1.04% w/w, compared to 24.50% w/w from loading an empty tube. The apparatus according to the present invention has reduced the level of breakages by a factor of more than 23 compared to free fall, and enabled loading rates that could fill the 12.7 m tube in 3.3 minutes (excluding intermediate checks).

| Small Pellet Loading | Breakages |
|---|---|
| Rate (m/min) | (% w/w) |
| 2.83 | 0.13 |
| 2.53 | 0.13 |
| 2.38 | 0.13 |
| 1.24 | 0.13 |
| 5.00 | 0.06 |

The average breakage resulting from loading small pellets using the apparatus of the present invention is 0.12% w/w, compared to 7.13% w/w from loading an empty tube. The apparatus has reduced the level of breakages by a factor of more than 54 compared to free fall, and enabled loading rates that could fill the 12.7 m tube in 2.5 minutes (excluding intermediate checks).

The performance of the apparatus of the present invention was then compared to an existing loading apparatus, as described in U.S. Pat. No. 5,247,970. The trials described above were repeated for the large and small catalyst pellets using rates typical for the apparatus and method loading rates.

| Large Pellet Loading | Breakage |
|---|---|
| Rate (m/min) | (% w/w) |
| 2.03 | 0.88 |
| 1.95 | 2.38 |
| 1.95 | 1.38 |

The average breakage resulting from loading large pellets using the apparatus described in U.S. Pat. No. 5,247,970 is 1.55% w/w. This is approximately 50% higher than the breakages resulting from using the apparatus described in the present invention. The 12.7 m tube could be loaded in 6.3 minutes (excluding intermediate checks). The present invention therefore permits loading in only 52% of this time.

| Small Pellet Loading | Breakage |
|---|---|
| Rate (m/min) | (% w/w) |
| 1.65 | 0.75 |
| 1.68 | 0.50 |
| 1.63 | 0.50 |

The average breakage resulting from loading small pellets using the apparatus described in U.S. Pat. No. 5,247,970 is 0.58% w/w. This is over 4 times higher than the breakages resulting from using the apparatus described in the present invention. The 12.7 m tube could be loaded in 7.6 minutes (excluding intermediate checks). The present invention permits loading in only 33% of this time.

After comparing the breakages, a comparison between the density variations resulting from loading using the present invention, and the variations from using U.S. Pat. No. 5,247,970 was made. Bulk density was calculated by measuring the volume of 101 mm diameter tube that was occupied by 8 kg of catalyst pellets. This was conducted for small and large pellets. Six loads were conducted for each size and apparatus.

The major difference between the two loading methods is that the present invention was used with 8 kg being loaded at an average of 20 seconds, with that of U.S. Pat. No. 5,247,970 used at its recommended rate of 8 kg in approximately 35 seconds to demonstrate that the present invention is consistent at a significantly faster rate.

| | Average | Standard |
|---|---|---|
| | Bulk Density | Deviation |
| | (kg/m³) | (kg/m³) |
| Large Pellets, Current Invention | 862 | 3.1 |
| Small Pellets, Current Invention | 992 | 11.8 |
| Large Pellets, U.S. Pat. No. 5,247,970 | 877 | 9.1 |
| Small Pellets, U.S. Pat. No. 5,247,970 | 1016 | 10.6 |

The results show that the present invention and the apparatus in U.S. Pat. No. 5,247,970 give comparable densities but that the apparatus of the present invention can load pellets considerably faster. All trials conducted result in a bulk density with a standard deviation of less than 1.2% of the average value. Assuming a normal distribution, and allowing 5% variability in loaded density, less than one in 32 thousand loadings would be expected to exceed this limit.

1. A method for loading a particulate catalyst into a vertical catalyst tube comprising;
(i) introducing catalyst loading apparatus into a vertical catalyst tube,
(ii) loading catalyst particles into the top of the tube whereinafter they contact said apparatus as they pass down the tube forming a uniform bed of catalyst beneath said apparatus, and
(iii) simultaneously removing the apparatus from the catalyst tube in timed relationship to the catalyst loading, wherein said apparatus comprises one or more deflector units, each deflector unit comprising a plurality of inclined deflector plates arranged on a rigid elongate member such that all the catalyst particles are deflected by one or more of said plates as they pass through each unit.

2. A method according to claim 1 wherein the deflector plates are arranged so that they define a deflecting surface around which is a gap between the peripheral edge of said surface and the inside of the tube wall said gap having a width less than half the size of the smallest catalyst particle dimension.

3. A method according to claim 1 or claim 2 wherein the uppermost edges of the deflector plates are curved.

4. A method according to any one of claims 1 to 3 wherein each elongate member supports between 1 and 20 deflector plates.

5. A method according to any one of claims 1 to 4 wherein each elongate member supports between 2 and 8 deflector plates.

6. A method according to any one of claims 1 to 5 wherein the inclination of each deflector plate to the axis of the tube is in the range 30-60 degrees.

7. A method according to any one of claims 1 to 6 wherein the deflector plates have one straight diameter edge and one curved circumferential edge and are semicircular when viewed from above.

8. A method according to any one of claims 1 to 6 wherein the deflector plates each have two straight radial edges and one curved circumferential edge.

9. A method according to claim 8 wherein the deflector plates are quadrants when viewed from above.

10. A method according to any one of claims 1 to 6 wherein the deflector unit has three opposed pairs of sector deflector plates whose radial edges are inwardly curved.

11. A method according to any one of claims 1 to 10 wherein when the catalyst particles follow a circuitous path as they descend, that the plates are arranged on the elongate members such that the particles move in a balanced clockwise and anticlockwise manner.

12. A method according to any one of claims 1 to 11 wherein the deflector units are separated at 0.5 to 2.5 metre intervals by a flexible rope, cable or wire.

13. A method according to any one of claims 1 to 12 wherein the catalyst particles comprise lobed or fluted cylinders having an aspect ratio less than 2.

14. Apparatus for loading a particulate catalyst into a vertical catalyst tube comprising one or more deflector units, each deflector unit comprising a plurality of inclined deflector plates arranged on a rigid elongate member such that all the catalyst particles are deflected by one or more of said plates as they pass through the or each unit.

15. Catalyst loading apparatus according to claim 14 wherein the deflector plates are arranged so that they define a deflecting surface around which is an annular void between the peripheral edge of said surface and the inside of the tube wall, said void having a width less than half the size of the smallest catalyst particle dimension.

16. Catalyst loading apparatus according to claim 14 or claim 15 wherein the uppermost edges of the deflector plates are curved.

17. Catalyst loading apparatus according to any one of claims 14 to 16 wherein each elongate member supports between 1 and 20 deflector plates.

18. Catalyst loading apparatus according to any one of claims 14 to 17 wherein each elongate member supports between 2 and 8 deflector plates.

19. Catalyst loading apparatus according to any one of claims 14 to 18 wherein the inclination of each deflector plate to the axis of the tube is in the range 30-60 degrees.

20. Catalyst loading apparatus according to any one of claims 14 to 19 wherein the deflector plates have one straight diameter edge and one curved circumferential edge and are semicircular when viewed from above.

21. Catalyst loading apparatus according to any one of claims 14 to 19 wherein the deflector plates each have two straight radial edges and one curved circumferential edge.

22. Catalyst loading apparatus according to claim 21 wherein the deflector plates are quadrants when viewed from above.

23. Catalyst loading apparatus according to any one of claims 14 to 19 wherein the deflector plates are sector deflector plates whose radial edges are inwardly curved.

24. Catalyst loading apparatus according to any one of claims 14 to 23 wherein when the catalyst particles follow a circuitous path as they descend, that the plates are arranged on the elongate members such that the particles move in a balanced clockwise and anticlockwise manner.

25. A method according to any one of claims 14 to 24 wherein the deflector units are separated at 0.5 to 2.5 metre intervals by a flexible rope, cable or wire.

26. Catalyst loading apparatus according to any one of claims 14 to 25 further comprising means for introducing and removing said apparatus from catalyst tubes.
